(19) United States
(12) Patent Application Publication
(10) Pub. No.: US 2014/0261349 A1
(43) Pub. Date: Sep. 18, 2014

(54) SYSTEM AND METHOD FOR SENSOR COOLING

(71) Applicant: CATERPILLAR INC., Peoria, IL (US)

(72) Inventor: Michael S. Radovanovic, Peoria, IL (US)

(73) Assignee: Caterpillar Inc., Peoria, IL (US)

(21) Appl. No.: 13/799,015

(22) Filed: Mar. 13, 2013

(51) Int. Cl. F02D 41/22

(52) U.S. Cl. CPC F02D 41/22
USPC 123/699

(57) ABSTRACT

A system located within an engine compartment is provided. The system includes a sensor mounted proximate to an engine. The system also includes a bleed line provided from an intake line associated with the engine. The bleed line is configured to provide a supply of compressed air to the sensor.

### TECHNICAL FIELD

The present disclosure relates to a sensor cooling system, more specifically for active cooling of a sensor which is placed proximate to an internal combustion engine.

### BACKGROUND

A variety of sensors are installed in an area proximate to an internal combustion engine in order to detect and/or measure a number of parameters associated with the engine. These parameters may include coolant temperatures, gas temperatures, exhaust gas constituent concentrations, and the like. The sensors may have constraints regarding the temperature at which they operate prior to failure. However, temperatures in an engine environment may exceed the temperature constraints of the sensor. The high temperature in the engine environment may cause a reduction in the operable life, and/or result in failure of, the sensor.

Various methods have been developed to cool these sensors including active cooling as well as passive cooling techniques. Passive cooling includes thermally shielding the sensor from heat. This can be done by insulating the sensor and/or placing a reflective material around the sensor. However, this solution may be insufficient over long operating cycles or may be unable to provide a needed degree of temperature differential between the operating environment and the sensor. Moreover, it may be difficult to access or place the covering over the sensor due to space constraints within an engine compartment. Similarly, known active cooling approaches include using an engine coolant to cool the sensor by heat exchange. However, the active cooling approach may unwantedly add cost and complexity to the sensor mounting and the sensor itself.

Japanese Patent Number 62078470 relates to a method for enabling a reduction in the size of a heater attached to an O₂ sensor. A device is provided which controls the opening of an EGR valve according to an output from an O₂ sensor detecting the O₂ concentration in suction air mixed with EGR gas, the O₂ sensor is so constituted as to be capable of being heated by means of exhaust heat.

The present disclosure presents a system and method which provides an approach for active cooling of the sensor in the engine environment that provides a desired temperature differential without adding significant complexity or cost to the sensor mount.

### SUMMARY OF THE DISCLOSURE

In one aspect of the present disclosure, a system located within an engine compartment is provided. The system includes a sensor mounted proximate to an engine. The system also includes a bleed line provided from an intake line associated with the engine. The bleed line is configured to provide a supply of compressed air to the sensor.

In another aspect, a method is provided. The method provides a sensor proximate to an engine within an engine compartment. The method also provides a bleed line from an intake line associated with the engine. The method further directs a flow of compressed air towards the sensor through the bleed line.

In yet another aspect, a system is provided. The system includes an engine located within an engine compartment. The system further includes a turbocharger associated with the engine. A sensor is mounted proximate to the engine. Further, a bleed line is provided from an intake line associated with the engine. The bleed line is configured to provide a supply of compressed air to the sensor.

Other features and aspects of this disclosure will be apparent from the following description and the accompanying drawings.

### BRIEF DESCRIPTION OF THE DRAWINGS

FIG. 1 is a diagrammatic view of an exemplary sensor cooling system, according to one embodiment of the present disclosure;

FIG. 2 is a diagrammatic view of another configuration of the sensor cooling system; and

FIG. 3 is a flowchart of a method for cooling a sensor provided proximate to an engine.

### DETAILED DESCRIPTION

Wherever possible, the same reference numbers will be used throughout the drawings to refer to the same or like parts. FIG. 1 is an exemplary configuration of a sensor cooling system 100, according to one embodiment of the present disclosure. Referring to FIG. 1, a sensor 102 may be mounted proximate to an engine 104. The sensor 102 may be placed within an engine enclosure, e.g., an engine enclosure of a machine or stand-by generator set. The sensor 102 may embody a variety of sensors such as, for example, a temperature sensor, a pressure sensor, a gas constituent sensor, and the like. These sensors may include any other sensors known in art that may be used for engine diagnostic purposes.

The engine 104 may be an internal combustion engine, one embodiment of which may be a diesel powered engine. The engine 104 may also be gasoline powered, gas powered, multi-fuel powered, or any combination thereof. Moreover, as shown in the accompanying figures, the engine 104 is a turbo charged engine. While the engine shown in the figures includes a single turbocharger, alternative embodiments include a series turbocharged engine or a super turbocharged engine. It should be understood that a conventional turbocharger 106 may employ a compressor 108, a turbine 110 and a cooler. The cooler may include a single stage or multistage air to air aftercooler 112 (hereinafter referred to as an ATAAC), a separate circuit aftercooler (SCAC) or an intercooler.

Referring to FIG. 1, the turbine 110 is coupled to the compressor 108. Further, the turbine 110 may also be connected to an exhaust line 114 associated with the engine 104. The compressor 108 is connected to an intake line 116 associated with the engine 104. One of ordinary skill in the art will appreciate that fresh air may be drawn into the compressor 108 in the direction of the arrowhead shown in the accompanying figures. The compressor 108 is configured to compress the air, which is subsequently supplied to the engine 104 via the intake line 116. The turbine 110 is configured to operate or run the compressor 108. The turbine 110 may be run by exhaust gases received via the exhaust line 114. The compressed air flowing from the compressor 108 towards the engine 104 may be cooled by the ATAAC 112 which is provided downstream of the compressor 108.

One of ordinary skill in the art will appreciate that the sensor 102 may be subjected to relatively high temperatures, of approximately above 200° C., due to proximity to the engine 104. The present disclosure relates to a bleed line 118 provided from the intake line 116 associated with the engine 104. The bleed line 118 is configured to provide active cooling of the sensor 102.

More specifically, the bleed line 118 is configured to divert at least a portion of the compressed air towards the sensor 102. As shown in FIGS. 1 and 2, the bleed line 118 may be provided downstream of the compressor 108, between the ATAAC 112 and the engine 104. The bleed line 118 may be a high pressure hose or a flexible conduit configured to provide a flow path for the pressurized cooled air exiting the ATAAC 112. Alternatively, the bleed line 118 may include high pressure metal tubing or any other tubing known in the art. Parameters related to the bleed line 118 such as, diameter, length, material used, and the like, may vary based on the application.

In one embodiment, a first end 120 of the bleed line 118 may be connected to the intake line 116 by means of a high pressure joint, or tapping. Alternatively, in another embodiment, as shown in FIG. 2, the first end 120 of the bleed line 118 may be connected to an intake manifold 202 of the engine 104. It should be noted that the connection of the bleed line 118 with the intake manifold 202 could be provided at a junction of the intake line 116 with the intake manifold 202 of the engine 104 or from the intake manifold 202 itself, as per system design and requirements. One of ordinary skill in the art will appreciate that this configuration may eliminate the need for the high pressure joint.

Further, a second end 122 of the bleed line 118 may be provided proximate to the sensor 102 in order to provide the supply of the compressed air to the sensor 102. It should be noted that the supply of compressed air may include carbon dioxide (CO₂) in systems which utilize exhaust gas recirculation. In one embodiment, the second end 122 of the bleed line 118 may be provided with a nozzle, in order to direct the supply of the compressed air over the sensor 102. In another embodiment, a baffle may be provided proximate to or partially surrounding the sensor 102, in order to promote the airflow over the sensor 102. Further, the compressed air passing through the second end 122 of the bleed line 118 may be vented to the atmosphere. The system may additionally include other components not described herein.

A method 300 for cooling the sensor 102 proximate to the engine 104 will be explained in connection with FIG. 3.

### INDUSTRIAL APPLICABILITY

During normal operation of the engine, an area proximate to the engine 104 may reach relatively high temperatures of approximately up to 200° C. Unless preventative measures are taken, extreme heat in the engine environment may tend to lower the operable life of the various sensors installed in the engine compartment.

The present disclosure provides an alternate active cooling technique which does not require the use of liquid engine coolant. The active cooling of the sensor 102 may assist providing a relatively acceptable sensor environment, thereby extending the life of the sensor 102.

At step 302, the sensor 102 is provided proximate to the engine 104 within the engine compartment of the machine. At step 304, the bleed line 118 is provided from the intake line 116 associated with the engine 104. This intake line 116 is configured to supply the compressed air from the compressor 108 to the engine 104. In one embodiment, the bleed line 118 may be connected to the intake line 116 downstream of the ATAAC 112. Alternatively, the bleed line 118 may also be connected to the intake manifold 202 of the engine 104.

During operation, the air taken up by the compressor 108 may flow towards the engine 104 via the intake line 116. In one embodiment, the compressed air may be cooled by the ATAAC 112. The cooling provided by the ATAAC may range approximately between 10 and 200° C. At step 306, at least a portion of the compressed air may be directed towards the sensor 102 through the bleed line 118. The compressed air flowing over the sensor 102 may facilitate in active cooling of the sensor 102. Thereafter, the compressed air may be vented to the atmosphere.

It should be noted that the compressed air exiting the ATAAC 112 may be at a high pressure and relatively cooler by approximately 10 to 600° C. than that of the engine environment. Hence, the compressed air flowing through the bleed line 118 may form an effective heat transfer medium and/or may serve to prevent contact of the high temperature air with the sensor 102. The disclosure described herein may be utilized within any engine application which includes sensors in a relatively hot environment.

While aspects of the present disclosure have been particularly shown and described with reference to the embodiments above, it will be understood by those skilled in the art that various additional embodiments may be contemplated by the modification of the disclosed machines, systems and methods without departing from the spirit and scope of what is disclosed. Such embodiments should be understood to fall within the scope of the present disclosure as determined based upon the claims and any equivalents thereof.

What is claimed is:

1. A system located within an engine compartment, the system comprising:
a sensor mounted proximate to an engine; and
a bleed line provided from an intake line associated with the engine, the bleed line configured to provide a supply of compressed air to the sensor.

2. The system of claim 1, wherein the engine includes a turbo charged engine.

3. The system of claim 1, wherein the bleed line is provided downstream of an after cooler.

4. The system of claim 3, wherein the after cooler includes at least one of an air to air after cooler and an intercooler.

5. The system of claim 3, wherein the supply of compressed air further comprises a cooled airflow exiting the after cooler.

6. The system of claim 1, wherein the bleed line includes a flexible conduit disposed between the intake line and the sensor.

7. The system of claim 1, wherein a nozzle is provided at an end of the bleed line proximate to the sensor.

8. The system of claim 1 further comprising a baffle positioned proximate to the sensor, the baffle configured to direct the supply of compressed air towards the sensor.

9. The system of claim 1, wherein the bleed line is connected to an intake manifold of the engine.

10. A method comprising:
providing a sensor proximate to an engine within an engine compartment;
providing a bleed line from an intake line associated with the engine; and
directing a flow of compressed air towards the sensor through the bleed line.

11. The method of claim 10, wherein providing the bleed line from an intake line associated with the engine further comprises providing the bleed line downstream of an after cooler.

12. The method of claim 10, wherein providing the bleed line from an intake line associated with the engine further comprises connecting the bleed line to an intake manifold of the engine.

13. The method of claim 10 further comprising cooling the compressed air prior to directing the flow of the compressed air towards the sensor.

14. A system comprising:
an engine located within an engine compartment;
a turbocharger associated with the engine;
a sensor mounted proximate to the engine; and
a bleed line provided from an intake line associated with the engine, the bleed line configured to provide a supply of compressed air to the sensor.

15. The system of claim 14 further comprising an after cooler, wherein the bleed line is provided downstream of the after cooler.

16. The system of claim 15, wherein the after cooler includes at least one of an air to air after cooler and an intercooler.

17. The system of claim 15, wherein the supply of compressed air further comprises a cooled airflow exiting the after cooler.
